(19) United States
(12) Patent Application Publication
(10) Pub. No.: US 2025/0005974 A1
(43) Pub. Date: Jan. 2, 2025

(54) REPAIR INFORMATION PROVISION APPARATUS AND REPAIR INFORMATION PROVISION METHOD

(71) Applicant: Honda Motor Co., Ltd., Tokyo (JP)

(72) Inventors: Takayuki Ishibashi, Tokyo (JP); Takahiro Yoshii, Tokyo (JP); Yudai Okabe, Tokyo (JP); Shogo Shibahara, Tokyo (JP); Hirofumi Yabu, Tokyo (JP); Kohei Mukaihara, Tokyo (JP); Kohei Saito, Tokyo (JP)

(21) Appl. No.: 18/749,618

(22) Filed: Jun. 21, 2024

(30) Foreign Application Priority Data
Jun. 28, 2023 (JP) 2023-105765

(51) Int. Cl. G07C 5/08

(52) U.S. Cl. CPC G07C 5/0816; G07C 5/0808; G07C 2205/02

(57) ABSTRACT

A repair information provision apparatus, includes: a processor and a memory coupled to the processor. The apparatus is configured to perform: acquiring first information including a diagnostic trouble code transmitted from a vehicle provided with an on-board diagnostics function; acquiring second information including a repair timing and a repair content of a repair performed on the vehicle and inputted by a worker; associating the diagnostic trouble code included in the first information with the repair content included in the second information based on a transmission timing of the first information and the repair timing included in the second information; storing a correspondence between the diagnostic trouble code and the repair content associated; and outputting repair information on the repair content corresponding to the diagnostic trouble code included in the first information based on the correspondence when the first information is acquired after the correspondence is stored.

### CROSS-REFERENCE TO RELATED APPLICATION

This application is based upon and claims the benefit of priority from Japanese Patent Application No. 2023-105765 filed on Jun. 28, 2023, the content of which is incorporated herein by reference.

### BACKGROUND OF THE INVENTION

### Field of the Invention

The present invention relates to a repair information provision apparatus and a repair information provision method configured to provide information on repairs of vehicles.

### Description of the Related Art

In the related art, there has been known a system that provides information on how to repair devices after the sale. For example, in a system described in JP 2003-228632 A, the diagnostic trouble code and the repair procedure for the trouble indicated by the diagnostic trouble code are associated and stored in advance in the server, and, when the diagnostic trouble code displayed on the device to be repaired is inputted through the mobile phone to the server through the network, the server returns the repair procedure for the fault represented by the diagnostic trouble code to the mobile phone.

Generally, vehicles are equipped with an On-Board Diagnostics (OBD), and the results of the diagnosis are outputted as Diagnostic Trouble Codes (DTCs). However, since the DTCs and the repair contents are not associated, it has been difficult to perform appropriate repairs on the vehicles based on the DTCs.

### SUMMARY OF THE INVENTION

An aspect of the present invention is a repair information provision apparatus, including: a processor and a memory coupled to the processor. The apparatus is configured to perform: acquiring first information including a diagnostic trouble code transmitted from a vehicle provided with an on-board diagnostics function; acquiring second information including a repair timing and a repair content of a repair performed on the vehicle and inputted by a worker; associating the diagnostic trouble code included in the first information with the repair content included in the second information based on a transmission timing of the first information and the repair timing included in the second information; storing a correspondence between the diagnostic trouble code and the repair content associated; and outputting repair information on the repair content corresponding to the diagnostic trouble code included in the first information based on the correspondence when the first information is acquired after the correspondence is stored.

Another aspect of the present invention is a repair information provision method, including the steps of: acquiring first information including a diagnostic trouble code transmitted from a vehicle provided with an on-board diagnostics function; acquiring second information including a repair timing and a repair content of a repair performed on the vehicle and inputted by a worker; associating the diagnostic trouble code included in the first information with the repair content included in the second information based on a transmission timing of the first information and the repair timing included in the second information; storing a correspondence between the diagnostic trouble code and the repair content associated; and outputting repair information on the repair content corresponding to the diagnostic trouble code included in the first information based on the correspondence when the first information is acquired after the correspondence is stored.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of an overall configuration of a repair information provision system including a repair information provision apparatus according to an embodiment of the present invention;

FIG. 2 is a drawing for explaining diagnosis information and repair information acquired by an information acquisition unit of FIG. 1;

FIG. 3 is a flow chart showing an example of a multiple DTC cleansing process executed by the repair information provision apparatus according to the embodiment of the present invention;

FIG. 4 is a flow chart showing an example of a diagnostic-tool DTC cleansing process executed by the repair information provision apparatus according to the embodiment of the present invention;

FIG. 5 is a flow chart showing an example of an association process executed by the repair information provision apparatus according to the embodiment of the present invention;

FIG. 6 is a flow chart showing an example of a versatility evaluation process executed by the repair information provision apparatus according to the embodiment of the present invention; and

FIG. 7 is a flow chart showing an example of a repair information provision process executed by the repair information provision apparatus according to the embodiment of the present invention.

### DETAILED DESCRIPTION OF THE INVENTION

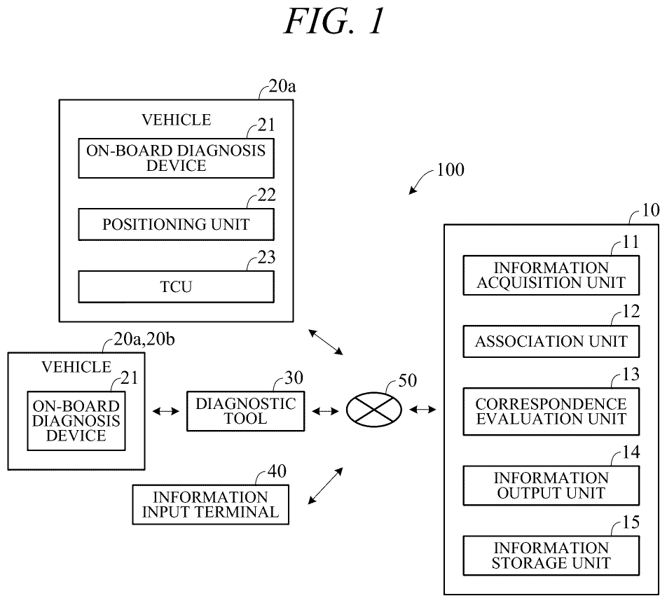

Hereinafter, an embodiment of the present invention will be described with reference to FIGS. 1 to 7. A repair information provision apparatus according to the embodiment of the present invention is configured to provide information on repairs of vehicles. Generally, vehicles are provided with on-board diagnostics (OBD) function, and the diagnosis results are outputted as a diagnostic trouble code (DTC). The DTCs indicate malfunction states detected by sensors on the vehicle, but they do not indicate the cause of such malfunction states or the appropriate repair methods to resolve them. For example, even if a DTC indicating a misfire state in a specific cylinder is output, it is not possible to determine whether this misfire state is due to a malfunction in the fuel injection system, a malfunction in the ignition system, or some other cause.

A worker who repairs a vehicle verifies the malfunction symptoms reported by the vehicle user and the DTCs outputted from the vehicle and inspects the areas considered to be the cause, identifies the cause of the malfunction, and determines the repair content. The repair content includes components (parts) to be repaired, replacements, cleaning, processing, and other treatments for the component to be repaired. When a specific malfunction occurs in a vehicle, usually, a certain malfunction state is detected, a certain DTC is outputted, and a certain repair content is determined by the worker. Therefore, in this embodiment, so as to easily perform appropriate repairs on the vehicle based on the DTCs newly outputted from the vehicle by associating the DTCs actually outputted from the vehicle in the past with the repair content at that time, the repair information provision apparatus is configured as follows.

FIG. 1 is a block diagram schematically illustrating an example of an overall configuration of a repair information provision system 100 including a repair information provision apparatus (apparatus) 10 according to the embodiment of the present invention. As shown in FIG. 1, the repair information provision system 100 includes the apparatus 10, vehicles 20a and 20b, a diagnostic tool 30, and an information input terminal 40 installed in a repair factory or the like for repairing the vehicle. The apparatus 10, the vehicle 20a, the diagnostic tool 30, and the information input terminal 40 are interconnected through a communication network 50, which includes a Local Area Network (LAN) and a Wide Area Network (WAN) such as the Internet, enabling them to communicate with each other.

The apparatus 10 includes a computer that includes a CPU (processor), ROM, RAM (memory), and other peripheral circuits. The apparatus 10 includes an information acquisition unit 11, an association unit 12, a correspondence evaluation unit 13, and an information output unit 14 as functional configurations of the processor, and includes an information storage unit 15 as a functional configuration of the memory. That is, the processor of the apparatus 10 functions as the information acquisition unit 11, the association unit 12, the correspondence evaluation unit 13, and the information output unit 14, and the memory of the apparatus 10 functions as the information storage unit 15. The apparatus 10 may be configured as a single server device, a distributed server device, or a distributed virtual server device provided in a cloud environment.

The vehicle 20a is provided with an on-board diagnosis device 21 that performs the on-board diagnostics function, a positioning unit 22, and a telematics control unit (TCU) 23. The positioning unit 22 receives positioning signals transmitted from positioning satellites and measures the current position of the vehicle 20a based on the received positioning signals. When a DTC is generated as a diagnosis result of the on-board diagnosis device 21, the TCU 23 transmits the DTC and the current position of the vehicle 20a (DTC generation position), measured by the positioning unit 22, to the apparatus 10 at a predetermined transmission cycle, along with the identification information of the vehicle 20 (vehicle ID). In other words, the TCU 23 transmits the DTC generated in the latest transmission cycle and the DTC generation position to the apparatus 10 along with the vehicle ID at each predetermined transmission cycle. The information transmitted from the vehicle 20a to the apparatus 10 is managed as diagnosis information via TCU on the apparatus 10 side. In the following, the DTC included in the diagnosis information via TCU may be referred to as “communication DTC”.

The DTCs include provisional DTCs temporarily generated due to errors and the like. For example, if a provisional DTC has been generated continuously for a certain number of diagnosis cycles, it changes to a confirmed DTC. Information as to whether each DTC is a provisional DTC or a confirmed DTC is included in the DTC itself, and it is possible to determine whether it is a provisional DTC or a confirmed DTC based on the DTC.

The vehicle 20b is provided with an on-board diagnosis device 21 that performs the on-board diagnostics function.

The diagnostic tool 30 is configured as a dedicated device or a general-purpose computer, and is connected to the on-board diagnosis device 21 of the vehicle 20a, 20b to be diagnosed through a communication line such as Controller Area Network (CAN). When the on-board diagnosis device 21 receives a diagnostic command from the diagnostic tool 30, it transmits the DTC generated in the past and stored in the memory to the diagnostic tool 30, or newly performs the on-board diagnostics function of the vehicles 20a, 20b and transmits the DTC generated in the diagnosis to the diagnostic tool 30. The on-board diagnosis device 21 transmits the vehicle ID of the vehicles 20a, 20b along with the DTC to the diagnostic tool 30. When the diagnostic tool 30 receives the DTC and the vehicle ID from the on-board diagnosis device 21, it transmits the received DTC and vehicle ID, along with the reception timing (DTC reception timing), to the apparatus 10. The information transmitted from the diagnostic tool 30 to the apparatus 10 is managed as diagnosis information via diagnostic tool on the apparatus 10 side. In the following, the DTC included in the diagnosis information via diagnostic tool may be referred to as “diagnostic tool DTC”.

The information input terminal 40 is configured, for example, as a device such as a personal computer, tablet terminal or the like installed in the repair factory for repairing the vehicle 20a, 20b, which can be connected to the communication network 50. Repair information on the repair of the vehicles 20a, 20b is inputted to the information input terminal 40. The repair information includes the identification information of the repair factory that performed the repair on the vehicles 20a, 20b (repair factory ID), the repair reception date, the vehicle ID, the malfunction symptoms (symptom code) to be repaired, and the repair content (parts number of the component to be repaired, specific treatment content). The repair information may include a DTC identified by the worker as a malfunction symptom related to the repair. The repair information inputted to the information input terminal 40 is transmitted to the apparatus 10 through the communication network 50 and is managed on the apparatus 10 side. In the following, the DTC included in the repair information may be referred to as the “inputted DTC”.

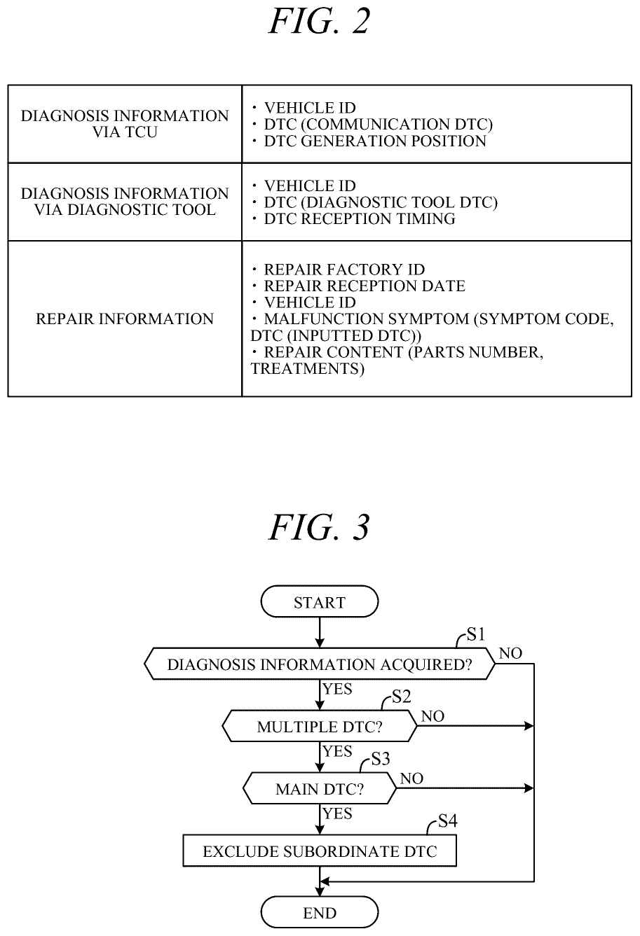

FIG. 2 is a drawing for explaining the diagnosis information and the repair information acquired by the information acquisition unit of the apparatus 10. As shown in FIG. 2, the information acquisition unit 11 of the apparatus 10 acquires the diagnosis information via TCU transmitted from the vehicle 20a (the TCU 23), the diagnosis information via diagnostic tool transmitted from the diagnostic tool 30, and the repair information transmitted from the information input terminal 40. The diagnosis information via TCU, the diagnosis information via diagnostic tool, and the repair information acquired by the information acquisition unit 11 are stored and accumulated in the information storage unit 15. The diagnosis information via TCU stored in the information storage unit 15 is supplemented with the timing information (DTC acquisition timing) when the diagnosis information was acquired by the information acquisition unit 11.

### Multiple DTC Cleansing Process

FIG. 3 is a flow chart showing an example of a multiple DTC cleansing process executed by the apparatus 10. The process of FIG. 3 is executed repeatedly at a predetermined interval. If multiple DTCs are generated simultaneously in one vehicle 20a, 20b, there is a possibility that subordinate DTCs are generated in conjunction with a main DTC related to the cause of the malfunction. For example, when a specific sensor fails, subordinate DTCs indicating a malfunction state of other onboard devices that use the output value from that sensor as an input value may be generated along with the main DTC indicating the specific sensor failure. When multiple DTCs are generated, it is preferable to exclude the subordinate DTCs and leave only the main DTC that should be associated with the repair content. The correspondence between the main DTC and the subordinate DTCs is stored in advance in the information storage unit 15 of the apparatus 10.

As shown in FIG. 3, first, in S1 (S: processing step), as a process in the information acquisition unit 11, it is determined whether the diagnosis information (diagnosis information via TCU, diagnosis information via diagnostic tool) has been acquired. If S1 is affirmative, the process proceeds to S2, while if S1 is negative, the process ends. In S2, it is determined whether the diagnosis information acquired in S1 includes multiple DTCs. If S2 is affirmative, the process proceeds to S3, while if S2 is negative, the process ends. In S3, it is determined whether the multiple DTCs acquired in S1 include the main DTC by referring to the correspondence between the main DTC and subordinate DTCs stored in the information storage unit 15. If S3 is affirmative, the process proceeds to S4, while if S3 is negative, the process ends. In S4, the subordinate DTCs corresponding to the main DTC identified in S3 are excluded (deleted, or added information indicating that they are not subject to association) from the multiple DTCs included in the diagnosis information acquired in S1, and the process ends. As a result, the subordinate DTCs are excluded from the DTCs (communication DTC, diagnostic tool DTC) included in the diagnosis information acquired by the information acquisition unit 11 and stored in the information storage unit 15, and the diagnosis information is updated.

### Diagnostic-Tool DTC Cleansing Process

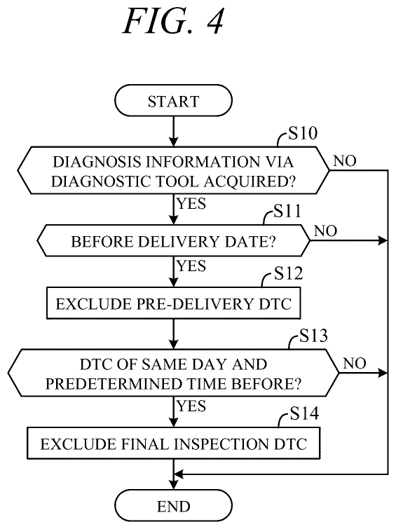

FIG. 4 is a flow chart showing an example of a diagnostic-tool DTC cleansing process executed by the apparatus 10. The process of FIG. 4 is executed repeatedly at a predetermined interval. The vehicles 20a and 20b are manufactured and undergo a final inspection at the manufacturing factory before delivery. During the final inspection, the diagnostic tool 30 is connected to the vehicle 20a, 20b, a simulated malfunction state is created in the vehicle 20a, 20b, and it is checked whether appropriate DTCs are outputted from the vehicle 20a, 20b to the diagnostic tool 30 and displayed on the diagnostic tool 30. The diagnostic tool DTCs generated before the delivery date of the vehicle 20a, 20b (pre-delivery DTC) should not be associated with the repair content and it is preferable to exclude them. The delivery date information of each vehicle 20a, 20b is stored in advance in the information storage unit 15 of the apparatus 10, associated with the vehicle ID.

As shown in FIG. 4, first, in S10, as a process in the information acquisition unit 11, it is determined whether the diagnosis information via diagnostic tool has been acquired. If S10 is affirmative, the process proceeds to S11, while if S10 is negative, the process ends. In S11, it is determined whether the delivery date corresponding to the vehicle ID included in the diagnosis information acquired in S10 is not recorded and it is before the delivery date, referring to the delivery date information of each vehicle 20a, 20b stored in the information storage unit 15. If S11 is affirmative, the process proceeds to S12, while if S11 is negative, the process ends. In S12, the diagnosis information acquired in S10 is excluded (deleted, or added information indicating that it is not subject to association) from the information storage unit 15. As a result, the pre-delivery DTC is excluded from the DTCs (diagnostic tool DTCs) included in the diagnosis information acquired by the information acquisition unit 11 and stored in the information storage unit 15, and the diagnosis information is updated.

The final inspection of the vehicle 20a, 20b using the diagnostic tool 30 is also performed after the repair of the vehicle 20a, 20b. In other words, before the repair of the vehicle 20a, 20b, a diagnosis using the diagnostic tool 30 is performed to identify the repair content, and after the repair, a final inspection using the diagnostic tool 30 is performed to confirm that the malfunction state has been resolved. The diagnosis before the repair and the final inspection after the repair are performed on the same day, and a predetermined time period (for example, 30 minutes) or more elapses from the diagnosis before the repair to the final inspection after the repair. In the final inspection after the repair, DTCs (final inspection DTCs) may be generated due to procedures during the final inspection, such as temporary removal of the battery terminal. Since the final inspection DTCs should not be associated with the repair content, it is preferable to exclude them.

In S13, the diagnosis information that includes the same vehicle ID as the vehicle ID included in the diagnosis information acquired in S10 is extracted from the diagnosis information via diagnostic tool stored in the information storage unit 15. Then, it is determined whether there is diagnosis information that includes a DTC reception timing that is the same day and a predetermined time period (for example, 30 minutes) or more before the DTC reception timing included in the diagnosis information acquired in S10, in the extracted diagnosis information. If S13 is affirmative, the process proceeds to S14, while if S13 is negative, the process ends. In S14, the diagnosis information acquired in S10 is excluded (deleted, or added information indicating that it is not subject to association) from the information storage unit 15, and the process ends. As a result, the final inspection DTC is excluded from the DTCs (diagnostic tool DTCs) included in the diagnosis information acquired by the information acquisition unit 11 and stored in the information storage unit 15, and the diagnosis information is updated.

The association unit 12 of the apparatus 10 associates the DTC included in the diagnosis information with the repair content included in the repair information based on the timing when the diagnosis information stored in the information storage unit 15 was transmitted and the repair timing included in the repair information stored in the information storage unit 15. The timing when the diagnosis information via TCU was transmitted is, for example, the timing (DTC acquisition timing) when the information acquisition unit 11 acquired the diagnosis information from the vehicle 20a (TCU 23). The timing when the diagnosis information via diagnostic tool was transmitted is, for example, the timing (DTC reception timing) when the diagnostic tool 30 received the diagnosis information from the vehicle 20a, 20b (on-board diagnosis device 21).

### Association Process

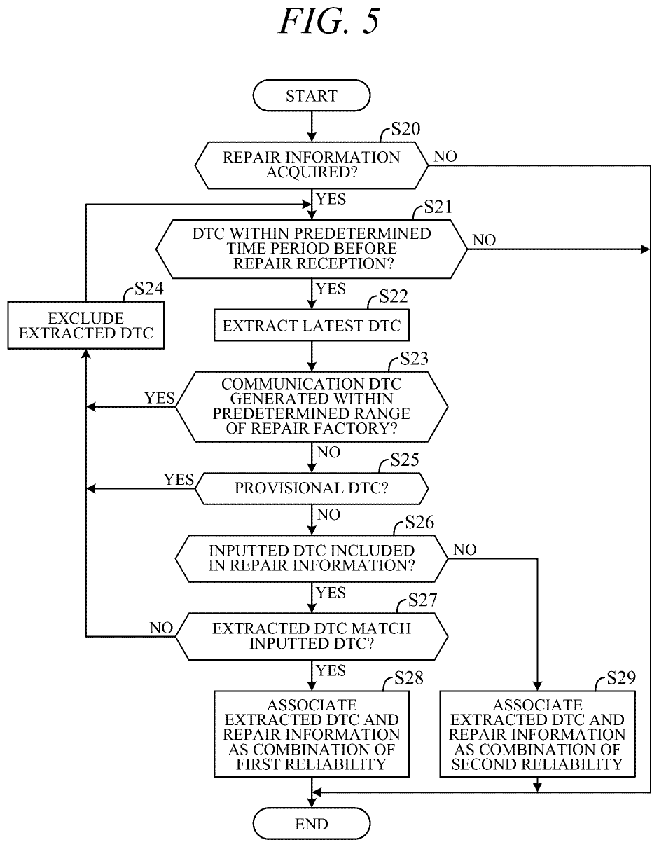

FIG. 5 is a flow chart showing an example of an association process executed by the apparatus 10. The process of FIG. 5 is executed repeatedly at a predetermined interval. When the repair of the vehicle 20a, 20b is completed, the repair information, which includes the repair content determined and actually performed by the worker, is inputted to the information input terminal 40 and transmitted to the apparatus 10 through the information input terminal 40. From the perspective of easily performing the appropriate repair of vehicles when the same trouble (malfunction state) occurs in similar vehicles, it is preferable to associate such repair content with the DTC (communication DTC, diagnostic tool DTC) related to the trouble that was the target of the repair.

As shown in FIG. 5, first, in S20, as a process in the information acquisition unit 11, it is determined whether the repair information has been acquired. If S20 is affirmative, the process proceeds to S21, while if S20 is negative, the process ends. In S21, as a process in the association unit 12, the diagnosis information including the same vehicle ID as the vehicle ID included in the repair information acquired in S20 is extracted from the diagnosis information stored in the information storage unit 15. Then, it is determined whether there is any diagnosis information within the predetermined time period from the repair reception date included in the repair information acquired in S20 in the extracted diagnosis information, based on the transmission timing (DTC acquisition timing, DTC reception timing). The predetermined time period is set to approximately 90 days from the DTC acquisition timing of the communication DTC to the repair reception date, and approximately 60 days from the DTC reception timing of the diagnostic tool DTC to the repair reception date, for example. If S21 is affirmative, the process proceeds to S22, while if S21 is negative, the process ends.

In S22, the diagnosis information with the latest transmission date (the date including DTC acquisition timing or DTC reception timing) that is the day before the repair reception date is extracted from the diagnosis information determined, in S21, to be within the predetermined period from the repair reception date. The diagnosis information extracted in S22 may include multiple DTCs (communication DTC, communication device DTC).

When a repair of the vehicle 20a, 20b is performed at the repair factory and a diagnosis before the repair and a final inspection after the repair are performed using the diagnostic tool 30, the diagnosis information via TCU may be transmitted along with the diagnosis information via diagnostic tool. Since the diagnosis information via TCU (communication DTC) generated during the repair should not be associated with the repair content, it is preferable to exclude it. The location of each repair factory is stored in advance in the information storage unit 15 of the apparatus 10, in association with the repair factory ID.

In S23, it is determined whether the diagnosis information extracted in S22 is the diagnosis information via TCU and generated within a predetermined range (for example, within about 200m) of the repair factory corresponding to the repair information acquired in S20. In other words, it is determined whether the DTC generation position included in the diagnosis information extracted in S22 is within the predetermined range of the location of the repair factory corresponding to the repair factory ID included in the repair information acquired in S20. If S23 is affirmative, the process proceeds to S24, where the diagnosis information (communication DTC) extracted in S22 is excluded (deleted, or added information indicating that it is not subject to association), and the process returns to S21. If S23 is negative, the process proceeds to S25. As a result, the diagnosis information via TCU (communication DTC) generated during the repair is excluded from the diagnosis information acquired by the information acquisition unit 11 and stored in the information storage unit 15, and the diagnosis information is updated.

In S25, it is determined whether the DTC (communication DTC, diagnostic tool DTC) included in the diagnosis information extracted in S22 is the provisional DTC. If S25 is affirmative, the process proceeds to S24, where the DTCs included in the diagnosis information extracted in S22 are excluded (deleted, or added information indicating that they are not subject to association), and the process returns to S21. If S25 is negative, the process proceeds to S26. As a result, the provisional DTC is excluded from the diagnosis information acquired by the information acquisition unit 11 and stored in the information storage unit 15, and the diagnosis information is updated.

The correspondence evaluation unit 13 of the apparatus 10 determines whether the repair information includes the inputted DTC and whether the DTC (communication DTC, diagnostic tool DTC) included in the diagnosis information matches the inputted DTC included in the repair information, and evaluates the correspondence based on the determination result. In other words, if the inputted DTC identified as related to the repair is included in the repair information inputted by the worker, the matching DTC (communication DTC, diagnostic tool DTC) is likely to be related to the repair content. On the other hand, the DTC (communication DTC, diagnostic tool DTC) that does not match the inputted DTC is likely not related to the repair content. If the repair information includes the inputted DTC, by considering it, the system can automatically evaluate the reliability of the correspondence between the associated DTC (communication DTC, diagnostic tool DTC) and the repair information.

In S26, as a process in the correspondence evaluation unit 13, it is determined whether the repair information acquired in S20 includes the inputted DTC. If S26 is affirmative, the process proceeds to S27, while if S26 is negative, the process proceeds to S29. In S27, it is determined whether the DTC (communication DTC, diagnostic tool DTC) included in the diagnosis information extracted in S22 matches the inputted DTC included in the repair information acquired in S20. More specifically, it is determined whether any DTC (communication DTC, diagnostic tool DTC) included in the diagnosis information extracted in S22 matches any inputted DTC included in the repair information acquired in S20. If S27 is negative, the process proceeds to S24, where the DTC included in the diagnosis information extracted in S22 is excluded (deleted, or added information indicating that it is not subject to association), and the process returns to S21. As a result, the DTC that does not match the DTC identified by the worker as related to the repair and are likely not related to the repair content are excluded from the diagnosis information acquired by the information acquisition unit 11 and stored in the information storage unit 15, and the diagnosis information is updated.

If S27 is affirmative, the process proceeds to S28, where, as a process in the association unit 12, the repair information acquired in S20 and the diagnosis information extracted in S22 are associated as a combination of the first reliability indicating high reliability, and the process ends. In S29, the repair information acquired in S20 and the diagnosis information extracted in S22 are associated as a combination of the second reliability indicating unknown reliability, and the process ends. The correspondence between the repair information and the DTC associated by the association unit 12 is stored in the information storage unit 15. The correspondence stored in the information storage unit 15 is supplemented with reliability information for each combination of the repair information and the DTC.

### Versatility Evaluation Process

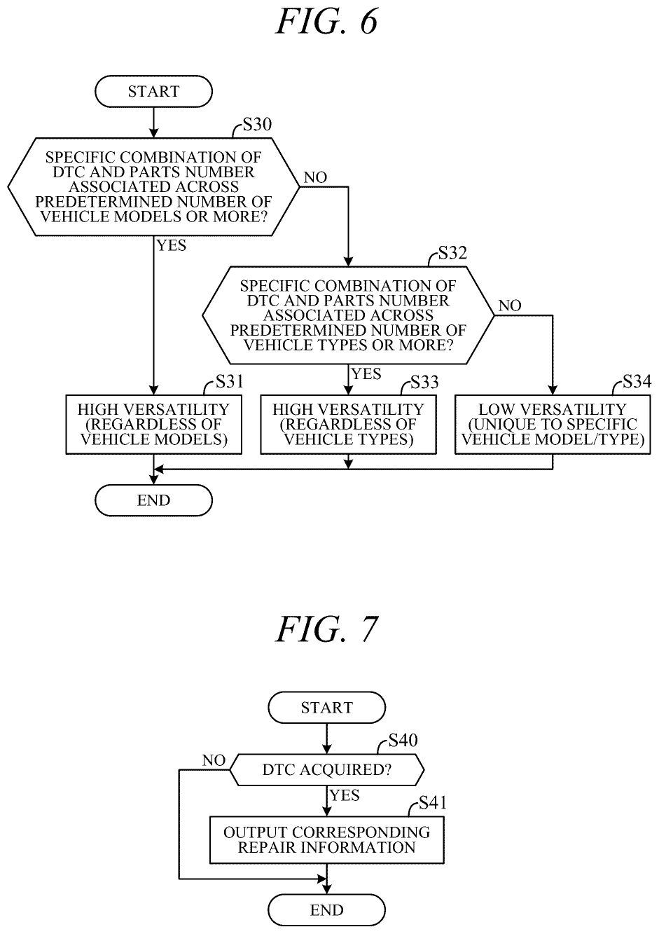

FIG. 6 is a flow chart showing an example of a versatility evaluation process executed by the apparatus 10. The process of FIG. 6 is executed for all combinations of the parts number of the repaired component contained in the repair information and the DTC, each time a new correspondence is stored in the information storage unit 15, for example. The correspondence evaluation unit 13 of the apparatus 10 evaluates the correspondence stored in the information storage unit 15 for each combination of the parts number of the repaired component included in the repair information and the DTC. More specifically, it is determined whether the DTC and the repaired component is associated across different vehicle models, and, if it is associated across different vehicle models, such correspondence is evaluated as a high versatility correspondence that is not dependent on the vehicle model. Also, it determines whether the DTC and the repaired component is associated across different types of the same vehicle model, and, if it is associated across different types, such correspondence is evaluated as a high versatility correspondence that is not dependent on the type. The model and type of each vehicles 20a, 20b (for example, model numbers that identify the vehicle model and the vehicle type) are stored in advance in the information storage unit 15 of the apparatus 10, in association with the vehicle ID.

As shown in FIG. 6, first, in S30, as a process in the correspondence evaluation unit 13, it is determined whether a specific combination of the parts number of the component to be repaired and the DTC is associated across a predetermined number of vehicle models or more. If S30 is affirmative, the process proceeds to S31, where evaluation information indicating that it is a high versatility correspondence regardless of the vehicle models is added to the specific combination of the parts number of the component to be repaired and the DTC, among the correspondences stored in the information storage unit 15, and the process ends. If S30 is negative, the process proceeds to S32, where it is determined whether the specific combination of the parts number of the component to be repaired and the DTC is associated across a predetermined number of types of the same vehicle model or more. If S32 is affirmative, the process proceeds to S33, where evaluation information indicating that it is a high versatility correspondence regardless of the vehicle types is added to the specific combination of the parts number of the component to be repaired and the DTC, among the correspondences stored in the information storage unit 15, and the process ends. If S32 is negative, the process proceeds to S34, where evaluation information indicating that it is a low versatility correspondence unique to the specific type of the specific vehicle model is added to the specific combination of the parts number of the component to be repaired and the DTC, among the correspondences stored in the information storage unit 15, and the process ends.

### Repair Information provision Process

FIG. 7 is a flow chart showing an example of a repair information provision process executed by the apparatus 10. The process of FIG. 7 is executed repeatedly at a predetermined interval. The information output unit 14 of the apparatus 10, after the correspondence between the repair information and DTC is stored in the information storage unit 15, outputs the repair information corresponding to the DTC included in the diagnosis information acquired by the information acquisition unit 11 based on the correspondence. More specifically, the information output unit 14 transmits the repair information as information related to the vehicle 20a, 20b, which is repaired at the repair factory, to the information input terminal 40 of the repair factory, which is responsible for the inspection, maintenance, repair and the like of the vehicle 20a, 20b that output the diagnosis information. In this way, by providing the repair information based on the diagnosis information acquired in the pre-repair diagnosis, it is possible to easily perform appropriate repair on the vehicle 20a, 20b at the repair factory. Also, when a trouble occurs in the vehicle 20a, if the repair information is provided based on the diagnosis information via TCU sent from the vehicle 20a to the apparatus 10, it is possible to identify the component to be repaired early at the repair factory, and to order the identified component early. The repair factory ID of the repair factory responsible for each vehicle 20a, 20b is stored in advance in the information storage unit 15 of the apparatus 10, associated with the vehicle ID.

As shown in FIG. 7, first, in S40, as a process in the information acquisition unit 11, it is determined whether the diagnosis information (diagnosis information via TCU, diagnosis information via diagnostic tool) has been acquired. If S40 is affirmative, the process proceeds to S41, while if S40 is negative, the process ends. In S41, the repair information corresponding to the DTC included in the diagnosis information acquired in S40 is transmitted to the information input terminal 40 of the repair factory corresponding to the vehicle ID by referring to the correspondence between the repair information stored in the information storage unit 15 and the DTC, and the process ends.

It may be possible to determine the output possibility of the repair information considering the evaluation result by the correspondence evaluation unit 13 stored in the information storage unit 15. For example, it may be possible to output the repair information on the condition that it is associated as a combination of the first reliability. It may be possible to identify the vehicle model and type corresponding to the vehicle ID included in the diagnosis information acquired in S40, and only output the repair information corresponding to the DTC included in the past diagnosis information of the vehicle 20a, 20b of the same model and type. On the condition that the evaluation information indicating that it is a high versatility correspondence regardless of the vehicle types is added, it may be possible to output the repair information corresponding to the DTC included in the past diagnosis information of the vehicle 20a, 20b of the same model but different type. On the condition that the evaluation information indicating that it is a high versatility correspondence regardless of the vehicle model is added, it may be possible to output the repair information corresponding to the DTC included in the past diagnosis information of the vehicle 20a, 20b of different models.

According to the present embodiment, the following effects can be achieved.

(1) The apparatus 10 includes: the information acquisition unit 11 that acquires the diagnosis information (diagnosis information via TCU, diagnosis information via diagnostic tool) including the DTC (communication DTC, diagnostic tool DTC) of the vehicle 20a, 20b transmitted from the vehicle 20a, 20b provided with the on-board diagnostics function and acquires the repair information including the repair timing and the repair content of the repair performed on the vehicle 20a, 20b and inputted by the worker; the association unit 12 that associates the DTC included in the diagnosis information with the repair content included in the repair information based on the transmission timing of the diagnosis information (DTC acquisition timing, DTC reception timing) and the repair timing (repair reception date) included in the repair information; the information storage unit 15 that stores the correspondence between the DTC and the repair content associated by the association unit 12; and the information output unit 14 that outputs the repair information on the repair content corresponding to the DTC included in the acquired diagnosis information based on the correspondence when the diagnosis information is acquired by the information acquisition unit 11 after the correspondence is stored in the information storage unit 15 (FIG. 1).

In this way, by associating the DTC transmitted from a specific vehicle and the repair content performed on that vehicle based on the transmission timing, for example, by associating a specific DTC and the first repair content performed after transmitting that DTC, it becomes possible to associate each DTC with appropriate repair content. Also, by providing the repair information related to the appropriate repair content corresponding to the newly transmitted DTC from the vehicle based on such correspondence between the DTC and the repair content, it becomes possible to easily perform appropriate repair of the vehicle based on the DTC.

(2) The apparatus 10 further includes: the correspondence evaluation unit 13 that determines whether the repair information includes the DTC and whether the DTC (inputted DTC) included in the diagnosis information matches the DTC included in the repair information and evaluates the correspondence stored in the information storage unit 15 based on the determination result (FIG. 1). The information output unit 14 outputs the repair information on the repair content corresponding to the DTC included in the acquired diagnosis information further based on the evaluation result by the correspondence evaluation unit 13 when the diagnosis information is acquired by the information acquisition unit 11 after the correspondence is stored in the information storage unit 15.

That is, if the repair information inputted by the worker includes the inputted DTC identified as related to the repair, the DTC (communication DTC, diagnostic tool DTC) that matches the inputted DTC is likely to be related to the repair content. On the other hand, the DTC (communication DTC, diagnostic tool DTC) that is different from the inputted DTC is likely not related to the repair content. By considering the inputted DTC that may be included in the repair information, it becomes possible to evaluate the reliability of the correspondence between the DTC (communication DTC, diagnostic tool DTC) and the repair content automatically associated by the system and to provide reliable repair information corresponding to the purpose.

(3) The repair information includes information on the repaired component (parts number) (FIG. 2). The apparatus 10 further includes: the correspondence evaluation unit 13 that determines whether the DTC and the repaired component is associated across different vehicle models and across different vehicle types of a same vehicle model and evaluates the correspondence stored in the information storage unit 15 based on the determination result (FIG. 1). The information output unit 14 outputs the repair information related to the repair content corresponding to the DTC included in the acquired diagnosis information based on the evaluation result by the correspondence evaluation unit 13 when the diagnosis information is acquired by the information acquisition unit 11 after the correspondence is stored in the information storage unit 15.

That is, if a specific DTC and repaired component are associated across different vehicle models or types, it is considered as a high versatility correspondence that applies to different vehicle models or types. On the other hand, if the DTC and the repaired component are associated only with a specific vehicle model or type, it is considered as a correspondence that arises due to quality issues or the like unique to the specific vehicle model or type, and applies only to that specific vehicle model or type. This allows for the provision of appropriate repair information.

In the above embodiment, an example was explained where an association is automatically performed each time the repair information is acquired, as shown in FIG. 5, etc. However, the associating of the diagnostic trouble code and the repair content is not limited to such. For example, the diagnostic trouble code included in the diagnosis information stored and accumulated in the information storage unit 15 may be associated with the repair content included in the repair information according to instructions from the outside. In other words, the association may be performed according to the request of the person receiving the provision of the repair information.

In the above embodiment, an example was explained where the repair information is outputted each time the diagnosis information is actually acquired as shown in FIG. 7, etc. However, the outputting of the repair information related to the repair content corresponding to the diagnostic trouble code is not limited to such. For example, corresponding repair information may be outputted in response to the input of virtual diagnosis information (diagnostic trouble code, vehicle model, type), or a list or the like showing the correspondence between the diagnostic trouble code and the repair information may be outputted.

In the above embodiment, although the present invention has been described as a repair information provision apparatus, the present invention can also be applied as a repair information provision method. Specifically, the repair information provision method includes the steps of: acquiring the diagnosis information (diagnosis information via TCU, diagnosis information via diagnostic tool) including the DTC (communication DTC, diagnostic tool DTC) of the vehicle 20a, 20b transmitted from the vehicle 20a, 20b provided with the on-board diagnostics function and the repair information including the repair timing and the repair content of the repair performed on the vehicle 20a, 20b and inputted by the worker (S1 in FIG. 3, S10 in FIGS. 4, and S20 in FIG. 5); associating the DTC included in the diagnosis information with the repair content included in the repair information based on the transmission timing of the diagnosis information (DTC acquisition timing, DTC reception timing) and the repair timing (repair reception date) included in the repair information (S21˜S29 in FIG. 5); storing the correspondence between the DTC and the repair content associated (S28 and S29 in FIG. 5); and outputting the repair information on the repair content corresponding to the DTC included in the diagnosis information based on the correspondence when the diagnosis information is acquired after the correspondence is stored (S41 in FIG. 7), each executed by a computer.

The above embodiment can be combined as desired with one or more of the aforesaid modifications. The modifications can also be combined with one another.

According to the present invention, it becomes possible to perform appropriate repairs on the vehicles based on the DTCs.

Above, while the present invention has been described with reference to the preferred embodiments thereof, it will be understood, by those skilled in the art, that various changes and modifications may be made thereto without departing from the scope of the appended claims.

1. A repair information provision apparatus, comprising:
a processor and a memory coupled to the processor, wherein
the apparatus is configured to perform:
acquiring first information including a diagnostic trouble code transmitted from a vehicle provided with an on-board diagnostics function;
acquiring second information including a repair timing and a repair content of a repair performed on the vehicle and inputted by a worker;
associating the diagnostic trouble code included in the first information with the repair content included in the second information based on a transmission timing of the first information and the repair timing included in the second information;
storing a correspondence between the diagnostic trouble code and the repair content associated; and
outputting repair information on the repair content corresponding to the diagnostic trouble code included in the first information based on the correspondence when the first information is acquired after the correspondence is stored.

2. The repair information provision apparatus according to claim 1, wherein
the apparatus is further configured to perform:
evaluating the correspondence based on a determination result as to whether the second information includes the diagnostic trouble code and whether the diagnostic trouble code included in the first information matches the diagnostic trouble code included in the second information, wherein
the apparatus outputs the repair information on the repair content corresponding to the diagnostic trouble code included in the first information further based on an evaluation result of the correspondence when the first information is acquired after the correspondence is stored.

3. The repair information provision apparatus according to claim 1, wherein
the second information includes information on a repaired component, wherein
the apparatus is further configured to perform:
evaluating the correspondence based on a determination result as to whether the diagnostic trouble code and the repaired component is associated across different vehicle models and across different vehicle types of a same vehicle model, wherein
the apparatus outputs the repair information on the repair content corresponding to the diagnostic trouble code included in the first information further based on an evaluation result of the correspondence when the first information is acquired after the correspondence is stored.

4. The repair information provision apparatus according to claim 1, wherein
the apparatus acquires the first information through a telematics control unit provided on the vehicle or a diagnostic tool connected to the vehicle, wherein
the transmission timing of the first information is a timing when the apparatus acquires the first information from the telematics control unit or a timing when the diagnostic tool acquires the first information from the vehicle.

5. The repair information provision apparatus according to claim 1, wherein
the apparatus acquires he second information through an information input terminal where the second information is inputted by the worker.

6. A repair information provision method, comprising the steps of:
acquiring first information including a diagnostic trouble code transmitted from a vehicle provided with an on-board diagnostics function;
acquiring second information including a repair timing and a repair content of a repair performed on the vehicle and inputted by a worker;
associating the diagnostic trouble code included in the first information with the repair content included in the second information based on a transmission timing of the first information and the repair timing included in the second information;
storing a correspondence between the diagnostic trouble code and the repair content associated; and
outputting repair information on the repair content corresponding to the diagnostic trouble code included in the first information based on the correspondence when the first information is acquired after the correspondence is stored.
